(19) United States
(12) Patent Application Publication
(10) Pub. No.: US 2009/0138575 A1
(43) Pub. Date: May 28, 2009

(54) INTERNET RADIO SYSTEM AND METHOD THEREFOR

(75) Inventors: Tsung-Ching LIN, Kaohsiung City (TW); En-Wei WU, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignees: MTECH CORPORATION, LTD., Taipei City (TW); I-SHOU UNIVERSITY, Kaohsiung County (TW)

(21) Appl. No.: 11/945,119

(22) Filed: Nov. 26, 2007

(51) Int. Cl. G06F 15/16

(52) U.S. Cl. 709/219

(57) ABSTRACT

An Internet radio system and method therefor are provided. The Internet radio system includes a server unit, a client unit, and an Internet radio dongle. The server unit contains an Internet radio station list database with built-in accessible Internet radio station list. To listen to online broadcast, user plugs the Internet radio dongle into the transmission interface of the client unit to enable the automatic execution of the Internet radio software program in the dongle and links up to an Internet radio station to listen to the broadcast by accessing the Internet ratio station link list in the Internet radio station list database via the Internet.

### BACKGROUND OF THE INVENTION

1. Field of the Invention

The present invention relates to an Internet radio system and method therefor, more particularly a system and a method for listening to Internet broadcast via a server unit with an Internet radio station list database that stores an accessible Internet radio station list and a client unit which can access the Internet radio link list with the plug-in of an Internet radio dongle.

2. Description of the Prior Art

Listening to radio is an indispensable part of modern life, for radio shows offer both entertainment and information. In line with the innovations in networking technology, radio broadcasters are digitalizing their service to offer online radio programs via Internet linkup.

However, listening to online radio broadcast nowadays requires the setting of online broadcast software program and searching for broadcast server. For users with little knowledge about computer and/or Internet, the process presents a challenge and inconvenience. In addition, oftentimes not all stations on the online radio station list provided by the online broadcast software program can be linked up, which can at times be a frustrating experience.

### SUMMARY OF THE INVENTION

To address the problem, the invention aims to provide an Internet radio system and method therefor that allows users to listen to online radio with an Internet radio dongle without settings or searching for the radio stations.

The Internet radio system comprises a server unit, a client unit and an Internet radio dongle. The server unit contains an Internet radio station list database, and through which, tests the accessible Internet radio stations. To listen to online broadcast, user plugs a transmission connector of the Internet radio dongle into the transmission interface of the client unit to enable the automatic execution of the Internet radio software program in the dongle and listens to the broadcast as the Internet radio software program obtains the accessible Internet radio station list in the Internet radio station list database of the server unit.

The way to listen to online broadcast according to the invention is that the Internet radio station list database in the server unit tests and updates the accessible Internet radio station list. When a user desires to listen to online broadcast, the user plugs the transmission connector of the Internet radio dongle into the transmission interface of the client unit to enable the automatic execution of the Internet radio software program built in the server unit and via the Internet, obtain the accessible Internet radio station list in the Internet radio station list database of the server unit for the application of the Internet radio software program. The user then operates the Internet radio software program to select the online radio station desired and have the client unit link up with the corresponding remote radio station via the Internet to listen to the broadcast.

The Internet radio system and method therefor according to the invention utilizes an Internet radio dongle, which is plugged into a client unit to execute automatically an Internet radio software program to obtain the accessible Internet radio list in the Internet radio station list database of the server unit. As such, the user can listen to online radio broadcast without settings or searching for radio stations.

### BRIEF DESCRIPTION OF THE DRAWINGS

FIG. 1 is a diagram illustrating the Internet radio system according to an embodiment of the invention;

FIG. 2 shows the circuit module of the Internet radio system according to an embodiment of the invention; and

FIG. 3 shows the implementation flow chart of the Internet radio listening method according to an embodiment of the invention.

### DETAILED DESCRIPTION OF THE INVENTION

The objects and features of the invention are described in detail below with embodiments in reference to the accompanying drawings.

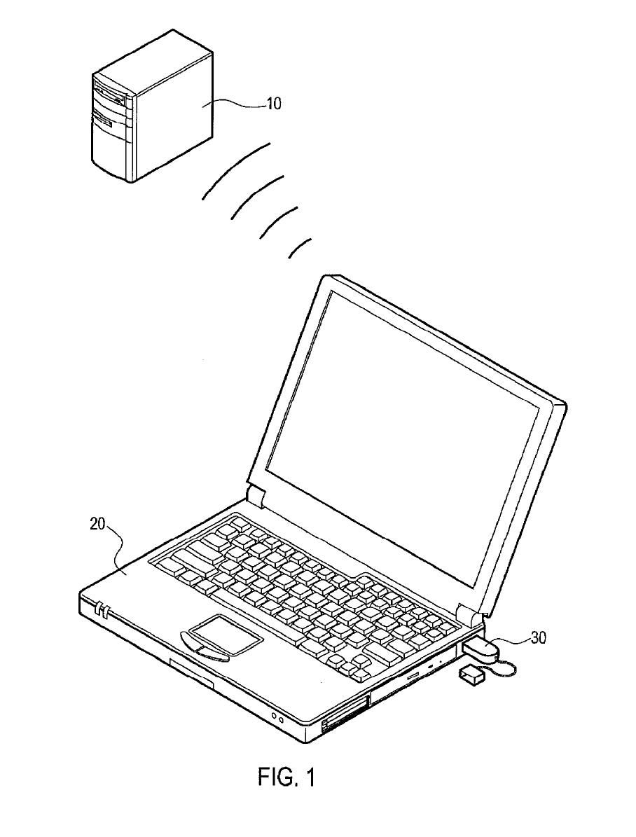

Referring to FIG. 1 which is a diagram illustrating the Internet radio system according to an embodiment of the invention, the Internet radio system comprises a server unit 10, a client unit 20 (e.g. a personal computer), and an Internet radio dongle 30.

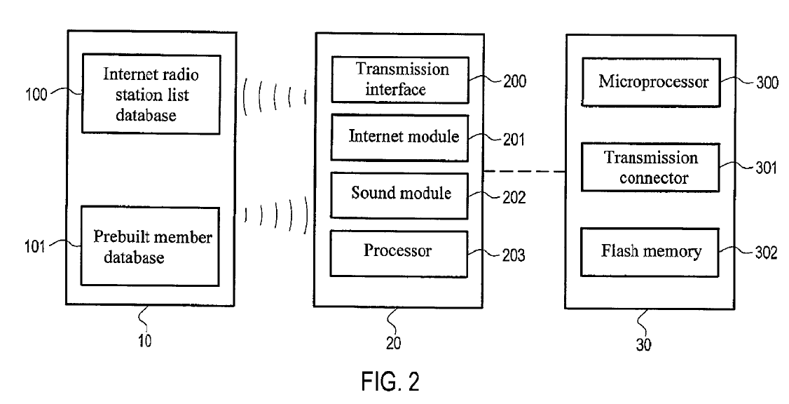

FIG. 2 shows the circuit module of the Internet radio system according to an embodiment of the invention. As shown, the server unit 10 is built in with an Internet radio station list database 100 and a prebuilt member database 101, and tests an accessible Internet radio list via the Internet radio station list database 100. The client unit 20 comprises at least a hot plug and plug-and-play transmission interface 200, an Internet module 201, a sound module 202 and a processor 203. The Internet radio dongle 30 consists of a microcontroller 300 built in with an interface driver, a transmission connector 301 and a flash memory 302 built in with an Internet radio software program.

The hot plug and plug-and-play transmission interface 200 of the client unit 20 is a USB or IEEE1394 at user's choice.

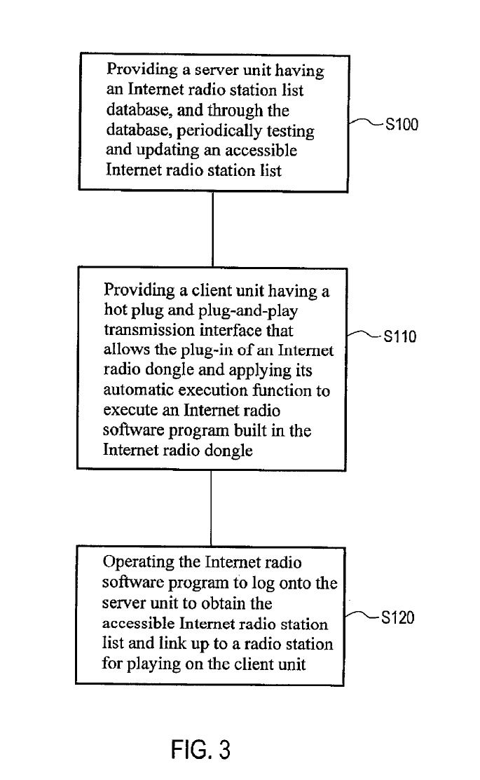

FIG. 3 shows the implementation flow chart of the Internet radio listening method according to an embodiment of the invention, which comprises the steps described below.

Again refer to FIG. 1 and FIG. 2 to help understand the working of the Internet radio system.

Provide a server unit 10 which has an Internet radio station list database 100 and periodically test and update an accessible Internet radio station list through the Internet radio station list database 100 (step S100). The Internet radio station list database 100 of the server unit 10 is built in with an accessible Internet radio station list, and links up with the Internet radio station server periodically for testing to update the accessible Internet radio station list therein to make sure user can listen to all Internet radio stations he/she links up to.

Provide a client unit 20 where an Internet radio dongle 30 is plugged into its hot plug and plug-and-play transmission interface 200 and the client unit 20 uses its automatic execution function to execute the Internet radio software program built in the Internet radio dongle 30 (step S110). When a user likes to listen to online broadcast, the user can plug the transmission connector 301 of the Internet radio dongle 30 into the hot plug and plug-and-play transmission interface 200 of the client unit 20, and through the microcontroller 300 of the Internet radio dongle 30, controls the connection between the Internet radio dongle 30 and the client unit 20 via interface driver to enable the automatic execution of the Internet radio software program built in the flash memory 302 of the Internet radio dongle 30.

Operate the Internet radio software program to log onto the server unit 10, obtain an accessible Internet radio station list and link to one of the stations on the list for playing on the client unit 20 (step S120). The user logs onto the server unit 10 via the Internet radio software program, goes through the verification process and prebuilt member database 101 to obtain a corresponding accessible Internet radio station list. User selects the station desired through the operational interface of the Internet radio software program and has the client unit 20 link to the corresponding remote Internet radio station via the Internet module 201 to receive the digital broadcast data from the Internet radio station. The processor 203 of the client unit 20 decodes the digital broadcast data and produces corresponding sound signals, which are played by the sound module 202 of the client unit 20.

The Internet radio system and method therefor described above is implemented by plugging the Internet radio dongle 30 into the transmission interface 200 of the client unit 20 and applying the automatic execution function of the client unit 20 to execute the Internet radio software program built in the Internet radio dongle 30, and via the Internet, obtain the accessible Internet radio station list in the Internet radio station list database 100 of the server unit 10. As such, the user can plug and play an online broadcast without going through tedious settings or radio station search.

The preferred embodiments of the present invention have been disclosed in the embodiments. However the embodiments should not be construed as a limitation on the actual applicable scope of the invention, and as such, all modifications and alterations without departing from the spirits of the invention and appended claims shall remain within the protected scope and claims of the invention.

What is claimed is:

1. An Internet radio system, comprising:
a server unit having an Internet radio station list database and an accessible Internet radio station list tested linkable by said Internet radio station list database;
a client unit networking with said server unit, said client unit having at least a hot plug and plug-and-play transmission interface; and
an Internet radio dongle having a transmission connector with the same interface as said transmission interface of said client unit and built in with an Internet radio software program.

2. The Internet radio system according to claim 1, wherein said Internet radio dongle further comprises:
a microcontroller for controlling the communication between said Internet radio dongle and said client unit; and
a flash memory electrically connected to said microcontroller and built in with said Internet radio software program.

3. The Internet radio system according to claim 1, wherein said client unit is a personal computer.

4. The Internet radio system according to claim 1, wherein said hot plug and plug-and-play transmission interface is a USB.

5. The Internet radio system according to claim 1, wherein said hot plug and plug-and-play transmission interface is an IEEE1394.

6. An Internet radio listening method, comprising the steps of:
providing a server unit having an Internet radio station list database and periodically testing and updating an accessible Internet radio station list through said Internet radio station list database;
providing a client unit having at least a hot plug and plug-and-play transmission interface for the plugging of an Internet radio dongle thereon and applying its automatic execution function to execute an Internet radio software program built in said Internet radio dongle; and
operating said Internet radio software program to log onto said server unit to obtain said accessible Internet radio station list and link up to one Internet radio station on said accessible Internet radio station list for playing on said client unit.

7. The Internet radio listening method according to claim 6, wherein said server unit further contains a prebuilt member database.

8. The Internet radio listening method according to claim 6, wherein the step of operating said Internet radio software program to log onto said server unit further includes a verification process for said server unit and providing a corresponding accessible Internet radio station list in line with said prebuilt member database.

9. The Internet radio listening method according to claim 6, further comprising the step of Internet radio software program storing the sounds from said linked Internet radio station in said client unit.
